(19) United States
(12) Patent Application Publication
(10) Pub. No.: US 2026/0077269 A1
(43) Pub. Date: Mar. 19, 2026

(54) CONTENT BASED RESPONSE TO A GAME PLAY QUERY USING ARTIFICIAL INTELLIGENCE

(71) Applicant: Sony Interactive Entertainment Inc., Tokyo (JP)

(72) Inventors: Andrew Herman, San Mateo, CA (US); Charlie Denison, San Mateo, CA (US)

(21) Appl. No.: 18/889,281

(22) Filed: Sep. 18, 2024

(51) Int. Cl. A63F 13/67; A63F 13/215

(52) U.S. Cl. CPC A63F 13/67; A63F 13/215

(57) ABSTRACT

A method includes capturing one or more video frames of a game play of the video game controlled by a user. The method including executing an artificial intelligence (AI) model to determine a context of a current point in the game play based on the one or more video frames that are captured. The method including determining a query based on the context of the game play using the AI model. The method including generating a response to the query using the AI model based on the context of the game play. The method including presenting the response to the query via a device of the player.

### TECHNICAL FIELD

The present disclosure is related to providing responses to queries during game play of a video game that is context aware using artificial intelligence. In particular, artificial intelligence is used to help users recall the correct names of in-game elements, and further provides additional context and/or information related to the in-game elements, such as by providing corresponding descriptions and/or linking and/or providing links to additional information over a communication network.

### BACKGROUND OF THE DISCLOSURE

Video games and/or gaming applications and their related industries (e.g., video gaming) are extremely popular and represent a large percentage of the worldwide entertainment market. Video games are played anywhere and at any time using various types of platforms, including gaming consoles, desktop computers, laptop computers, mobile phones, tablet computers, etc.

Frequently, a player has questions regarding a video game. These questions may be basic (e.g., name of an object, etc.) as the video game may be new to the player and is unaware of basic facts about the video game, or the player has not played the game for a period of time and has forgotten basic facts about the video game. The questions may be complex (e.g., how to beat a boss), especially as the player progresses through a video game.

However, processing a query for the benefit of the player may take more time than is allowed, especially when trying to provide real-time answers to a player during a game play. For instance, accessing game state for the game play from a developer server of the video game involves many processing steps to including translating the game state to a useable format, determining which game state corresponds to the game play from the voluminous amount of game state data, and processing the corresponding game state for the benefit of answering the query, etc. All these processing steps may be too involved to allow for real-time processing of a query.

Also, the player may not have the time or the interest to fully seek answers to questions that may arise, which may require providing to a third party search application, configured to answer questions about the video game, complete search parameters that provide all the preliminary details necessary to generate a sufficient answer to a query. As outlined above, even if the player provided a complete query to the search application, an answer to the query as processed by the search application may not be provided in real-time due to processing constraints.

Further, the player may not have time or the interest to perform self-research to obtain answers to questions about the video game, especially while the player is in the heat of the moment while playing the game, or in the middle of a discussion with another person about the video game. As such, in each of these situations the player may not wish to read a walkthrough or short description about the video game while playing the game.

It is in this context that embodiments of the disclosure arise.

### SUMMARY

Embodiments of the present disclosure relate to identifying active and/or passive queries and generating responses to those queries using artificial intelligence that is context aware of a current point in a game play of a video game. The same process can be used to identify passive and/or active queries related to the presentation of media content, such as movies, and the generation of responses to those queries.

In one embodiment, a method is disclosed. The method including capturing one or more video frames of a game play of the video game controlled by a user. The method including executing an artificial intelligence (AI) model to determine a context of a current point in the game play based on the one or more video frames that are captured. The method including determining a query based on the context of the game play using the AI model. The method including generating a response to the query using the AI model based on the context of the game play. The method including presenting the response to the query via a device of the user.

In another embodiment, another method is disclosed. The method including capturing one or more video frames during a presentation of a movie. The method including executing an artificial intelligence (AI) model to determine a context of a current point in the presentation of the movie based on the one or more video frames that are captured. The method including determining a query related to the presentation of the movie based on the context using the AI model. The method including generating a response to the query using the AI model based on the context of the presentation of the movie. The method including presenting the response to the query via a device of a viewer of the movie.

In still another embodiment, a computer system is disclosed, wherein the computer system includes a processor and memory coupled to the processor and having stored therein instructions that, if executed by the computer system, cause the computer system to execute a method. The method including capturing one or more video frames of a game play of the video game controlled by a user. The method including executing an artificial intelligence (AI) model to determine a context of a current point in the game play based on the one or more video frames that are captured. The method including determining a query based on the context of the game play using the AI model. The method including generating a response to the query using the AI model based on the context of the game play. The method including presenting the response to the query via a device of the user.

Other aspects of the disclosure will become apparent from the following detailed description, taken in conjunction with the accompanying drawings, illustrating by way of example the principles of the disclosure.

### BRIEF DESCRIPTION OF THE DRAWINGS

The disclosure may best be understood by reference to the following description taken in conjunction with the accompanying drawings in which:

FIG. 1 illustrates a system configured for identifying queries related to a game play of a video game and generate responses to the queries using artificial intelligence that is context aware of a current point in the game play, in accordance with one embodiment of the present disclosure.

FIG. 2A is a flow diagram illustrating a method for processing queries related to a game play of a video game using artificial intelligence that is context aware of during the game play of the video game, in accordance with one embodiment of the present disclosure.

FIG. 2B is a flow diagram illustrating a method for identifying queries related to a presentation of a movie, and generate responses to the queries using artificial intelligence that is context aware of a current point in the presentation, in accordance with one embodiment of the present disclosure.

FIG. 3 is an illustration of a system configured to implement an AI model configured for classifying contexts corresponding to one or more points during a game play of a video game, and to identify queries related to the game play and generate responses to the queries using artificial intelligence that is context aware of during the game play of the video game, in accordance with one embodiment of the present disclosure.

FIG. 4 illustrates a user interface used for interacting with a query agent that is configured to identifying queries related to a game play of a video game and generate responses to the queries using artificial intelligence that is context aware of a current point in the game play, in accordance with one embodiment of the present disclosure.

FIG. 5 illustrates an index of in-game elements of a video game that is built using artificial intelligence, in accordance with one embodiment of the present disclosure.

FIG. 6 illustrates components of an example device that can be used to perform aspects of the various embodiments of the present disclosure.

### DETAILED DESCRIPTION

Although the following detailed description contains many specific details for the purposes of illustration, anyone of ordinary skill in the art will appreciate that many variations and alterations to the following details are within the scope of the present disclosure. Accordingly, the aspects of the present disclosure are set forth without any loss of generality to, and without imposing limitations upon, the claims that follow this description.

Generally speaking, the various embodiments of the present disclosure describe systems and methods for identifying active and/or passive queries and generating responses to those queries using artificial intelligence that is context aware of a current point in a game play of a video game. As such, artificial intelligence can be used to augment the user's knowledge of the video game, especially when the user is having difficulty remembering basic facts of the game (e.g., character names, object names, basic lore, etc.). Artificial intelligence can be used to recognize a query (e.g., active or passive) by the user based on a context of a game play, such as when the user is struggling to remember information about the video game, whether or not the user actively presents an active query. Further, artificial intelligence can be used to generate a response to the query, wherein the response is based on the context of a game play of the video game. In one implementation, artificial intelligence can be used for the indexing of in-game elements (e.g., characters, weapons, locations, etc.) of a video game. The in-game elements can be accessed from the index when generating responses to identified queries related to those in-game elements. In particular, artificial intelligence may be used to reference an in-game element of the video game via keywords in the query and the determined context. Further, artificial intelligence may be used to access from the index information related to the in-game element and generate a response to the query using the information related to the in-game element. The same process can be used to identify passive and/or active queries related to the presentation of media content, such as movies, and the generation of responses to those queries.

Advantages of the methods and systems, configured to identify active and/or passive queries and generating responses to those queries using artificial intelligence that is context aware of a current point in a game play of a video game, include the identification of active and/or passive queries of a player playing a video game, using artificial intelligence that is context aware in the game play. As such, the user need not devote time to craft a detailed and intricate query message that provides details regarding the video game, the current context of the video game, objects relevant to the query, and other information related to the query. Instead, because the artificial intelligence is context aware of a current point in the game play, any query, including basic and/or incomplete queries, is understandable based on the known context of the game play. Further, the query may be identified using artificial intelligence whether or not the user actively presents the query. That is, artificial intelligence may be used to passively identify a query based on the context of the game play without the knowledge of the user. For instance, the user may be uttering comments during the game play, or the user may be communicating with another person or another player during the game play, wherein in the comments and/or communication the user is uninformed and/or unknowledgeable about certain aspects of the video game relevant to the comments and/or communication. For example, the user may misidentify objects or cannot identify objects mentioned in the comments and/or communication. In addition, the response to the query is generated using artificial intelligence based on the context of the game play. In that manner, the user is able to be fully aware of information related to the video game during activities related to the game play of the video game (e.g., the game play, discussions about the game play, etc.). In one implementation, artificial intelligence is used to help the user recall the correct names of in-game elements, and further can be used to provide additional context and/or information related to the in-game elements, such as by providing corresponding descriptions and/or linking and/or providing links to additional information over a communication network (e.g., internet).

Throughout the specification, the reference to “game” or video game” or “gaming application” is meant to represent any type of interactive application that is directed through execution of input commands. For illustration purposes only, an interactive application includes applications for gaming, word processing, video processing, video game processing, etc. Also, the terms “virtual world” or “virtual environment” or “metaverse” is meant to represent any type of environment generated by a corresponding application or applications for interaction between a plurality of users in a multi-player session or multi-player gaming session. Furthermore, the term “platform” refers to a combination of hardware and software components providing a set of capabilities in order to execute one or more software applications (e.g., video games). For example, the term “platform” may be used with reference to “devices of a particular platform” or “cross-platform devices.” Moreover, suitable terms introduced above are interchangeable.

With the above general understanding of the various embodiments, example details of the embodiments will now be described with reference to the various drawings.

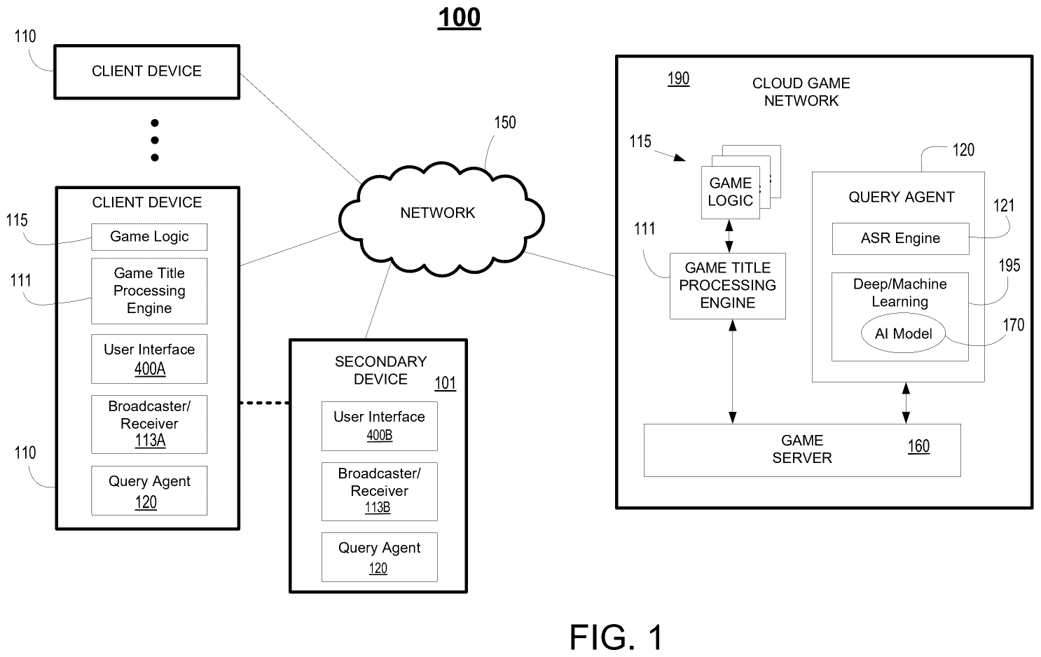

FIG. 1 illustrates a system 100 configured for identifying queries related to a game play of a video game and generate responses to the queries using artificial intelligence that is context aware of a current point in the game play, in accordance with one embodiment of the present disclosure. In that manner, the user is more knowledgeable about their game play of a video game, which allows the user to better understand their game play and/or better enjoy activities revolving around the game play, such as knowledgeably discussing the video game with others.

As shown, system 100 may provide gaming over a network 150 for one or more client devices 110 of one or more users. In particular, system 100 may be configured to enable users to interact with interaction applications, including provide gaming to users participating in a single-player or multi-player gaming sessions (e.g., participating in a video game in single-player or multi-player mode, or participating in a metaverse generated by an application with other users, etc.) via a cloud game network 190, wherein the game can be executed locally (e.g., on a local client device 110 of a corresponding user) or can be executed remotely from a corresponding client device 110 (e.g., acting as a thin client) of the corresponding user that is playing the video game, in accordance with one embodiment of the present disclosure. In at least one capacity, the cloud game network 190 supports a multi-player gaming session for a group of users, to include delivering and receiving game data of players for purposes of coordinating and/or aligning objects and actions of players within a scene of a gaming world or metaverse, managing communications between user, etc., so that the users in distributed locations participating in a multi-player gaming session can interact with each other in the gaming world or metaverse in real-time. In another capacity, the cloud game network 190 supports multiple users participating in a metaverse.

In some embodiments, the cloud game network 190 may include a plurality of virtual machines (VMs) running on a hypervisor of a host machine, with one or more virtual machines configured to execute a game processor module utilizing the hardware resources available to the hypervisor of the host. It should be noted, that access services, such as providing access to games of the current embodiments, delivered over a wide geographical area often use cloud computing. Cloud computing is a style of computing in which dynamically scalable and often virtualized resources are provided as a service over the internet.

In a multi-player session allowing participation for a group of users to interact within a gaming world or metaverse generated by an application (which may be a video game), some users may be executing an instance of the application locally on a client device (e.g., gaming console, tablet, mobile phone, etc.) to participate in the multi-player session. Other users who do not have the application installed on a selected device or when the selected device is not computationally powerful enough to executing the application may be participating in the multi-player session via a cloud based instance of the application executing at the cloud game network 190.

As shown, the cloud game network 190 includes a game server 160 that provides access to a plurality of video games. Applications played in a corresponding single player and/or multi-player session may be played over the network 150 with connection to the game server 160. For example, in a multi-player session involving multiple instances of an application (e.g., generating virtual environment, gaming world, metaverse, etc.), a dedicated server application (session manager) collects data from users and distributes it to other users so that all instances are updated as to objects, characters, etc. to allow for real-time interaction within the virtual environment of the multi-player session, wherein the users may be executing local instances or cloud based instances of the corresponding application. In particular, game server 160 may manage a virtual machine supporting a game processor that instantiates a cloud based instance of an application for a user. As such, a plurality of game processors of game server 160 associated with a plurality of virtual machines is configured to execute multiple instances of one or more applications associated with gameplays of a plurality of users. In that manner, back-end server support provides streaming of media (e.g., video, audio, etc.) of gameplays of a plurality of applications (e.g., video games, gaming applications, etc.) to a plurality of corresponding users. That is, game server 160 is configured to stream data (e.g., rendered images and/or frames of a corresponding gameplay) back to a corresponding client device 110 through network 150. As such, a computationally complex gaming application may be executing at the back-end server in response to controller inputs received and forwarded by client device 110. Each server is able to render images and/or frames that are then encoded (e.g., compressed) and streamed to the corresponding client device for display.

In single-player or multi-player sessions, instances of an application may be executing locally on a client device 110 or at the cloud game network 190. In either case, the application as game logic 115 is executed by a game engine 111 (e.g., game title processing engine). For purposes of clarity and brevity, the implementation of game logic 115 and game engine 111 is described within the context of the cloud game network 190. In particular, the application may be executed by a distributed game title processing engine (referenced herein as “game engine”). In particular, game server 160 and/or the game title processing engine 111 includes basic processor based functions for executing the application and services associated with the application. For example, processor based functions include 2D or 3D rendering, physics, physics simulation, scripting, audio, animation, graphics processing, lighting, shading, rasterization, ray tracing, shadowing, culling, transformation, artificial intelligence, etc. In that manner, the game engines implement game logic, perform game calculations, physics, geometry transformations, rendering, lighting, shading, audio, as well as additional in-game or game-related services. In addition, services for the application include memory management, multi-thread management, quality of service (QoS), bandwidth testing, social networking, management of social friends, communication with social networks of friends, social utilities, communication channels, audio communication, texting, messaging, instant messaging, chat support, game play replay functions, help functions, etc.

In one embodiment, the cloud game network 190 may support artificial intelligence (AI) based services including chatbot services (e.g., ChatGPT, etc.) that provide for one or more features, such as conversational communications, composition of written materiel, composition of music, answering questions, simulating a chat room, playing games, and others.

Users access the remote services with client devices 110, which include at least a CPU, a display and input/output (I/O). For example, users may access cloud game network 190 via communications network 150 using corresponding client devices 110 configured for providing input control, updating a session controller (e.g., delivering and/or receiving user game state data), receiving streaming media, etc. The client device 110 can be a personal computer (PC), a mobile phone, a personal digital assistant (PAD), handheld device, etc.

The client devices 110 may be operating using different platforms. For example, one or more client devices may be operating on a first platform (e.g., gaming consoles), and other client devices may be operating a different platform (mobile phones). In still another platform, a platform includes both a client device and game server 160 located at the cloud game network 190 in support of a cloud based instance of an application. As previously described, each platform may include a combination of hardware and software components providing a set of capabilities in order to execute one or more software applications (e.g., video games).

In particular, client device 110 of a corresponding user is configured for requesting access to applications over a communications network 150, such as the internet, and for rendering for display images generated by a video game executed by the game server 160, wherein encoded images are delivered (i.e., streamed) to the client device 110 for display. For example, the user may be interacting through client device 110 with an instance of an application executing on a game processor of game server 160 using input commands to drive a gameplay. Client device 110 may receive input from various types of input devices, such as game controllers, tablet computers, keyboards, touch screens, gestures captured by video cameras, mice, touch pads, audio input, etc.

As previously introduced, client device 110 may be configured with a game title processing engine and game logic 115 (e.g., executable code) that is locally stored for at least some local processing of an application, and may be further utilized for receiving streaming content as generated by the application executing at a server, or for other content provided by back-end server support. In another implementation, client decide 110 acts as a stand-alone system for purposes of executing the application, such as when supporting a game play of a video game.

In another embodiment, client device 110 may be configured as a thin client providing interfacing with a back end server (e.g., game server 160 of cloud game network 190) configured for providing computational functionality (e.g., including game title processing engine 111 executing game logic 115—i.e., executable code—implementing a corresponding application).

In addition, system 100 includes a query agent 120 configured to identify active and/or passive queries of a user, identify relevant information, and generate responses to those queries using artificial intelligence. In particular, the artificial intelligence is context aware of a current point in a game play of a video game when the query was identified. In that manner, the query is identified within some context from which a response can be generated. As such, the artificial intelligence is able to identify and/or formulate the query given a particular context in the game play, even with a minimal amount of information that may be incomplete and seemingly irrelevant without supporting information provided by the user to actively fill in the context, and further generate a response based on the context that is identified using artificial intelligence.

The query agent 120 may be implemented at the back-end cloud game network, or as a middle layer third party service that is remote from the client device. In some implementations, the query agent 120 may be located at a client device 110 and/or the secondary device 101. That is, the query agent 120 may be local to a user, such as operating within a client device 110 and/or a secondary device 101 of the user, or may be remote from the user and operate at a back-end server. For instance, the query agent 120 may be operating in isolation in the client device 110, wherein the client device may provide interfacing with the user via user interface 400A and/or the broadcaster/receiver 113A. Also, the query agent 120 may be operating in isolation in the secondary device 101 of the user, wherein the secondary device may provide interfacing with the user via user interface 400B and/or the broadcaster/receiver 113. Further, the query agent 120 may be operating cooperatively using both the client device 110 and the secondary device 101. For instance, the client device 110 (e.g., game console) may provide the processing for the query agent 120, and the secondary device 101 (e.g., mobile phone) may provide interfacing with the user, such as via a user interface 400B or the broadcaster/receiver 113B. In another embodiment, the client device 110 and/or the secondary device 101 act as a front-end for a query agent 120 operating at the back-end of system 100 (i.e., at the cloud game network 190), wherein the front end provides for interfacing with the user (e.g., via a corresponding user interface or broadcaster/receiver).

In any implementation, the client device 110 and/or the secondary device 101 provide interfacing with the user, to include monitoring communication, receiving queries, and deliver responses to those queries back to the user with the cooperation of a query agent (i.e., local or back-end). For example, the client device 110 and/or the secondary device 101 may be configured to receive communications from a user, such as via the broadcaster/receiver 113A in audio or video format, or via the user interface 400A in text format. The communication is processed by the query agent using artificial intelligence to identify a context of a game play, and/or to identify a query, and/or identify information relevant to the identified query, and/or generate a response to an identified query based on the context of a game play, wherein the response may use the identified information. In one implementation, the user actively provides a query related to the video game. In another implementation, the player may not actively provide a query, and instead is associated with a passive query that is identified using artificial intelligence, given a particular context of the game play that is identified. For example, artificial intelligence may be used to analyze communication by the user to identify a passive query that is relevant to the user for a given context of a game play of a video game.

In one embodiment, the query agent 120 may include an automatic speech recognition (ASR) engine 121 that is configured to optionally translate communications by a user from a first format to a second format. For example, communication may come in the form of audio from the user, and the ASR engine 121 is configured to translate the audio communication to another format (e.g., text) that is more suitable for a downstream device and/or component to handle (e.g., analyze, process, etc.). As an illustration, the ASR engine 121 may also be configured to transform text to audio, such that a response received in text format can be broadcast in an audio format (e.g., via broadcaster/receiver). In some embodiments, the ASR engine 121 may require a significant amount of resources, such as when performing artificial intelligence that may be implemented using a deep learning engine. In that manner, the translated data may be critical when determining a query using artificial intelligence.

The query agent 120 is configured to classify and/or identify using artificial intelligence a current context of a game play of a video game, such as through analysis of video frames and/or screen shots of the game play. The query agent 120 is also configured to using artificial intelligence identify a query (e.g., passive or active) associated with a user playing the video game through an analysis of communications from the user that may be based on the current context of the game play. Because the artificial intelligence is context aware, a query may be identified even though the communication may generally not be specific enough to be relevant to generate a valid query for the video game. The query agent 120 may also be configured to generate a response to the identified query, to include identifying relevant information that can be used in the response. The classification and/or identification of queries, and the generation of a response to those queries may be performed using artificial intelligence (AI) via an AI layer. For example, the AI layer may be implemented via an AI model 170 as executed by a deep/machine learning engine 195 of the query agent 120. It is understood that one or more AI models may be implemented, each of which being configured to perform customized classification and/or identification and/or generation of data (e.g., identify a query, identify relevant information, generate a response to the query, etc.).

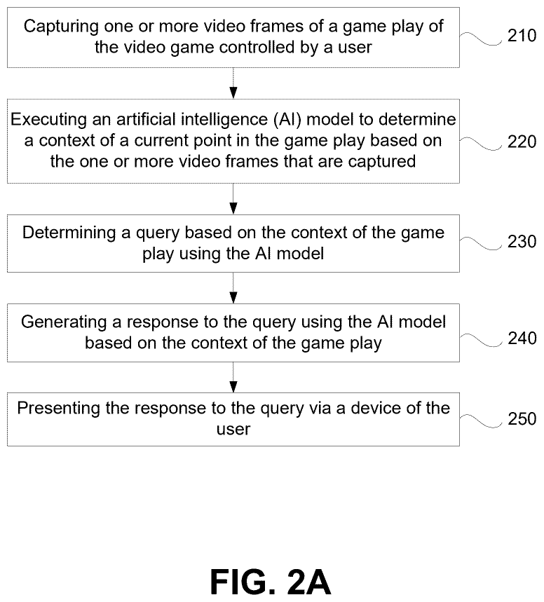

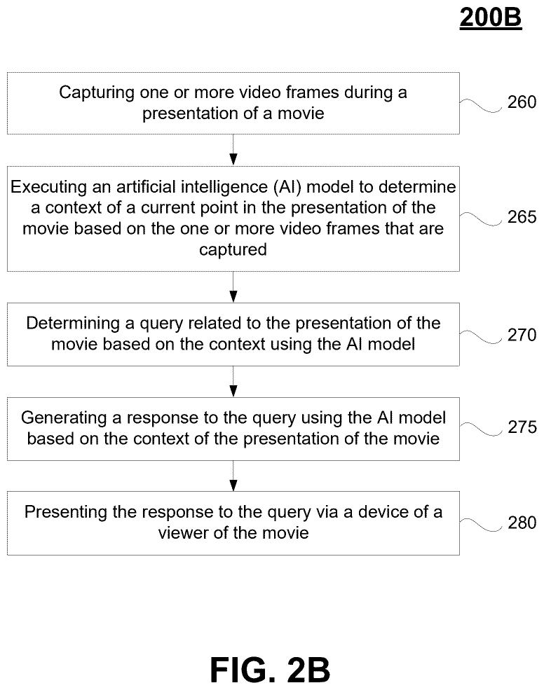

With the detailed description of the system 100 of FIG. 1, flow diagram 200A of FIG. 2A discloses a method for processing queries related to a game play of a video game using artificial intelligence that is context aware of during the game play of the video game, in accordance with one embodiment of the present disclosure. In that manner, a user is made aware of information related to a video game that is not necessarily known to the user during activities related to game play of the video game, such as during communications about the video game. The operations performed in the flow diagram may be implemented by one or more of the previously described components of system 100 described in FIG. 1, including the query agent 120.

At 210, the method includes capturing one or more video frames of a game play of the video game controlled by a user. In particular, screen shots of the game play (e.g., the video frames) can be analyzed in real-time for purposes of providing query agent services. That is, the video frames are selected for processing over other data, which may require cumbersome processing that extend beyond real-time analysis in order to provide the same services. For instance, the screen shots and/or video frames are utilized instead of capturing game state from the game play. Game state capture may require cooperation with a developer of the video game to allow for access to the game state on developer servers (e.g., active access of game state in databases of the developer), or constantly receiving streaming of the game state from the developer. The game state is associated with all the game plays of all the developer's video games, and further includes massive amounts of data that may or may not be relevant to query identification and response generation for a particular video game. Further, the game state data may have to be translated into a useable format by downstream components. Preliminary processing includes parsing the game state data to find relevant data, and further translating the data to a useable format for processing. This preliminary processing may be too complex to allow for real-time analysis for purposes of identifying queries and generating responses to those queries. Additional processing of the relevant game state data is still required for query identification and response generation, which may also not allow for providing responses to queries beyond of real-time analysis. That is, all of the preliminary and additional processing of the game state may be too involved to allow for real-time processing. On the other hand, video frame analysis can be performed for purposes of identifying queries and generating responses to those queries, in embodiments of the present disclosure, as will be further described below.

At 220, the method includes executing an artificial intelligence (AI) model to determine a context of a current point in the game play based on the one or more video frames that are captured. In one implementation, the AI model is trained using a plurality of video frames captured from a plurality of game plays of the video game, wherein the game plays are controlled by one or more players. In particular, the AI model is trained to classify and/or identify a plurality of contexts of a plurality of points in the plurality of game plays of the video frame based on the plurality of video frames that are captured. In that manner, the AI model is able to classify and/or identify the context of the current point in the game play by matching the context of the current point in the game play to one of the plurality of contexts of the video game identified during training.

In one embodiment, the AI model is reinforced and/or validated during training using game state captured from the plurality of game plays. Since there is no pressure to provide real-time analysis, capturing and analyzing game state is possible in order to classify and/or identify and/or reinforce/verify the plurality of contexts.

The context of a current point in a game play may include relevant information useful for identifying a query by a user. For example, the context may include a game title of the video game. Additional context may be determined for the current point, such as a corresponding scene, level in the video game, objects encountered, mapping location, other characters in the scene, loadout of a character, etc.

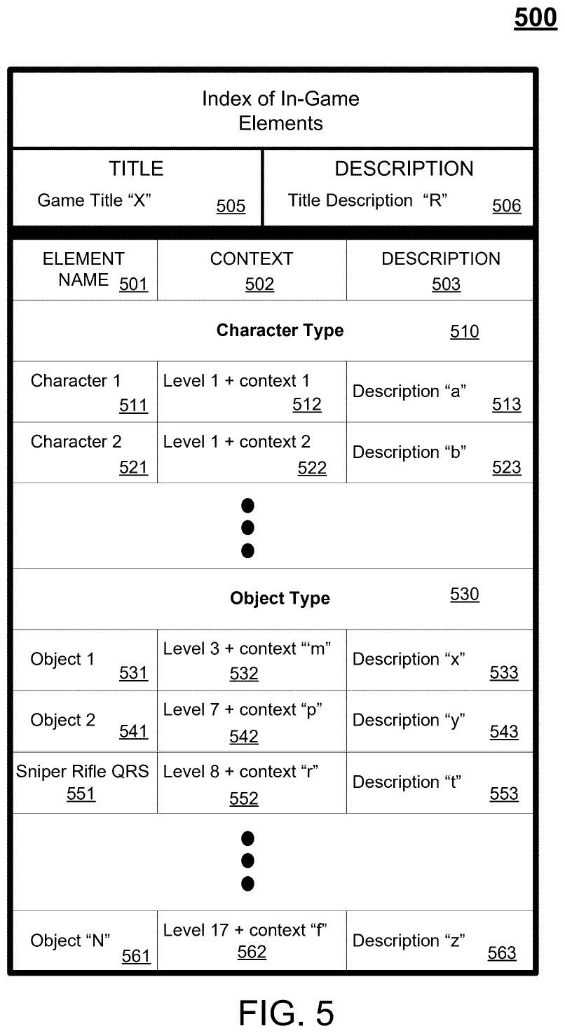

In addition, during training the AI model may be configured to classify and/or identify one or more in-game elements of the video game. In one implementation, a plurality of game state and/or video frames (e.g., screen shots) is captured from the plurality of game plays of the video game controlled by one or more players. The AI model is then trained to identify a plurality of in-game elements of the video game, and includes information related to the plurality of in-game elements. A database or index may be built by the AI model to include the plurality of in-game elements and a plurality of descriptions corresponding to the plurality of in-game elements. An illustration of the index of in-game elements is provided in FIG. 5.

At 230, the method includes determining a query based on the context of the game play using the AI model. In particular, artificial intelligence is used to determine and/or identify active and/or passive queries based on the context even with a minimum amount of and/or seemingly non-specific information used for determining the query, including the meaning of the query. Because the artificial intelligence is context aware of a current point in the game play, any bits of information relevant to a query that is actively and/or passively obtained, including basic and/or incomplete information, can be used to identify a query based on the known context of the game play. For example, two video games may generally have the same obstacle (e.g., a water crossing through a gushing stream), and a generic communication by the user (e.g., how do I get over there) without additional context would be useless (would not even know the relevant video game and/or the task facing the user in the video game) in determining an actual query useful to the user (e.g., how do I cross the stream). However, with the proper context determined via the AI model, the video game being played can be determined, and a relevant scene or task being presented is also known. As such, a proper query can be determined that asks for relevant information related to crossing the stream, as is encountered for a current point in the game play of the video game.

In one embodiment, the user actively provides a query related to the game play of the video game. An active query is directly provided by the user with the intention of receiving a response to the query. For example, a query may be received via a user interface presented on a device of the user, wherein the user actively enters (e.g., in text format) in the query. An automatic speech recognition engine may be used to understand the query and translate the query to format suitable for input into the AI model for processing, wherein the ASR engine may utilize text and/or speech recognition techniques. In another implementation, a voice communication (e.g., audio format) of the user may be monitored for active presentation of the query by the user. The ASR engine may be used to translate the audio to a format suitable for ASR analysis and/or input into the AI model for processing. Because the query is actively provided, the AI model may not be necessary to identify the query when the query itself provides the context and is complete; however, when the ASR engine is unable to fully recognize the query, additional analysis using the AI model may be required, such as to provide the necessary context.

In another embodiment, the user passively provides a query related to the game play of the video game. A passive query is indirectly provided by the user, and without any intention of receiving a response. For example, a communication of the user may be monitored. The communication may be self-directed, such as the user not talking to anyone in particular. Also, the communication may be a conversation between two or more persons talking about the video game, such as when two players are playing the video game in a multi-player session are chatting (e.g., in a chat thread, or over a chat channel, or over a mobile phone connection, etc.). The chat thread may be translated to a format for input into the AI model, such as using an ASR engine. As such, the query can be identified using artificial intelligence based on the communication and the identified context. For illustration, a user may be unable to properly identify an object within the game play during a communication and/or conversation. As a result, passive query may be identified that requests information related to the object (e.g., name, description, etc.).

At 240, the method includes generating a response to the query using the AI model based on the context of the game play. In particular, the AI model is configured to match and/or generate a suitable response for the identified query, such as by matching a pre-generated response to the query and/or generating a new response to the query.

In one embodiment, the AI model is configured to identify an in-game element relevant to the query, and generate the response using information related to the in-game element. For instance, the query may be directed to the in-game element, or the in-game element is necessary to process the query. The database or index may be accessed to access the description corresponding to the in-game element that is identified, wherein the information related to and/or the description of the in-game element may be used by the AI model when generating a response to the query. In another implementation, third party data sources (e.g.,, websites) may be accessed to obtain the description related to the in-game element that is identified for purposes of generating the response. For example, the description from the third party data source may be directly included in the response, or may be indirectly referenced, such as by providing a link to the description of the in-game element in the response. As an illustration, the query may request a general description of the first level of the video game, wherein the response provides a link to a third party website that provides a walkthrough of the first level. As another illustration, the query may be directed to an object in the video game and/or the lore behind the object, wherein the object corresponds to an in-game element. The response may include information for the in-game element accessed from the database or index built by the AI model, or accessed from a third party website.

At 250, the method includes presenting the response to the query via a device of the user, wherein the response may be of any format suitable for communication. In one implementation, the response is broadcasted using a speaker of a device of the user, wherein the response is formatted in an audio format. For example, the device may be a game console providing query agent services to include the speaker, or the device may be a secondary device (e.g., mobile phone) having a speaker that supports the game console for executing the query agent. In another implementation, the response is presented in a user interface presented on the device of the user, wherein the response is formatted in a text format. For example, the device may be a game console providing query agent services to include a display showing the user interface, or the device may be a secondary device (e.g., mobile phone) having a display for showing the user interface.

In one embodiment, spoilers are identified in the response using the AI model. When the response includes information that may be in conflict with (e.g., spoils) the current point in the game play of the video game, then the information is prevented from being presented to the user. For example, a query that is identified may be directed to an object or in-game element, and the AI model is used to generate information related to the object, such as basic information about the object, and more complex information, such as the lore behind the object. When the information related to the object, and/or the object itself is determined to be a spoiler of the lore of the video game for the current point in the game play (e.g., not generally present at or before the current point in the game play), then the presentation of the information in the response to the query is restricted so as to not spoil the video game for the user.

In another embodiment, the player is able to automatically or manually control pausing and restarting of the game play of the video game while the query is identified and processed. For example, the user can select an option for automatic control, such that while a query is being processed execution of an instance of the video game supporting the game play is automatically paused, and automatically restarted after presentation of the response. In another example, the user is able to manually control pause and restart. In this case, the user may be given control over execution of the instance when a query is identified and is being processed, such as via a selectable button on a user interface or through a voice command. Control over the instance by the user may be limited to times when a query is being processed. As such, the user may manually pause execution of the instance of the video game supporting the game play while the query is being processed, and manually restart the instance of the video game after the response is presented.

With the detailed description of the system 100 of FIG. 1, flow diagram 200B of FIG. 2B discloses a method for identifying queries related to a presentation of a movie, and generate responses to the queries using artificial intelligence that is context aware of a current point in the presentation, in accordance with one embodiment of the present disclosure. In that manner, a user is made aware of information related to a movie that is not necessarily known to a viewer during activities related to presentation of the movie, such as during communications about the movie or its family of movies. The operations performed in the flow diagram may be implemented by one or more of the previously described components of system 100 described in FIG. 1, including the query agent 120. Further, the operations performed in flow diagram 200A of FIG. 2A related to processing of queries related to a video game may be implemented within the operations performed in flow diagram 200B for the processing of queries related to a presentation of a movie, to include identifying queries, identifying information related to the queries, and generating responses to those queries.

At 260, the method includes capturing one or more video frames (e.g., screen shots) during a presentation of a movie. The screen shots of the presentation can be analyzed in real-time for purposes of providing query agent services.

At 265, the method includes executing an artificial intelligence (AI) model to determine a context of a current point in the presentation of the movie based on the one or more video frames that are captured. In one implementation, the AI model is trained using a plurality of video frames captured from one or more presentations of the movie. Specifically, the AI model is trained to identify a plurality of contexts of a plurality of points in the movie or any presentation of the movie based on the plurality of video frames that are captured. As such, the AI model is configured to classify and/or identify a context of a current point in the presentation of the movie by matching the context of the current point to one of the plurality of contexts of the movie identified during training. Further, the AI model may be trained to identify contexts at different points of relative movies, such as within a family or franchise of movies.

The context of a current point in the presentation of the movie may include relevant information useful for identifying a query by a viewer. For example, the context may include a title of the movie. Additional context may be determined for the current point, such as a corresponding scene, objects encountered, characters in the scene, etc.

In addition, during training the AI model may be configured to classify and/or identify one or more elements of the movie. For example, a plurality of game state and/or video frames (e.g., screen shots) is captured from a presentation of the movie. The AI model is then trained to identify a plurality of elements of the movie, and includes information related to the plurality of elements. A database or index may be built by the AI model to include the plurality of elements and a plurality of descriptions corresponding to the plurality of in-game elements.

At 270, the method includes determining a query related to the presentation of the movie based on the context using the AI model. Artificial intelligence is used to determine and/or identify active and/or passive queries based on the context even with a minimum amount of and/or seemingly non-specific information used for determining the query, including the meaning of the query. Because the artificial intelligence is context aware of a current point in the presentation of the movie, any bits of information relevant to a query that is actively and/or passively obtained, including basic and/or incomplete information, can be used to identify a query based on the identified context. The query may even corresponding to a family or franchise of movies.

As previously described, in one embodiment the user actively provides a query related to the movie. For example, the query may be received via a user interface presented in a device of the viewer, wherein the query may be formatted in text or audio, or any other suitable format. The query may be submitted via a voice command and received by a receiver of the device, wherein the voice of the viewer is continually monitored. An automatic speech recognition engine may be used to understand the query and translate the query to format suitable for input into the AI model for processing, wherein the ASR engine may utilize text and/or speech recognition techniques. Because the query is actively provided, the AI model may not be necessary to identify the query when the query itself provides the context and is complete; however, when the ASR engine is unable to fully recognize the query, additional analysis using the AI model may be required, such as to provide the necessary context.

In another embodiment, the user passively provides a query related to the game play of the video game. For example, a communication of the user may be monitored. The communication may be self-directed, such as the user not talking to anyone in particular. Also, the communication may be a conversation between two or more persons viewing the movie. The communication may be between persons locally situated (i.e., in person), or between persons remotely situated. For example, the communication may be over a social media thread or via a mobile phone channel. The communication may be translated to a format for input into the AI model, such as using an ASR engine. As such, the query can be identified using artificial intelligence based on the communication and the identified context.

At 275, the method includes generating a response to the query using the AI model based on the context of the presentation of the movie. For example, the AI model is configured to match and/or generate a suitable response for the identified query, such as by matching a pre-generated response to the query and/or generating a new response to the query.

At 280, the method includes presenting the response to the query via a device of a viewer of the movie, wherein the response may be of any format suitable for communication. In one implementation, the response is broadcasted using a speaker of a device of the user, wherein the response is formatted in an audio format. In another implementation, the response is presented in a user interface presented on the device of the user, wherein the response is formatted in a text format.

In one embodiment, spoilers are identified in the response using the AI model. When the response includes information that may be in conflict with (e.g., spoils) the current point in the presentation of the movie or within a family/franchise of movies, then the information is prevented from being presented to the user. For example, a query that is identified may be directed to an character, and the AI model is used to generate information related to the character. When the information related to the character, and/or the character itself is determined to be a spoiler of the plot of the movie for the current point in the presentation of the movie (e.g., not generally present at or before the current point), then the presentation of the information in the response to the query is restricted so as to not spoil the presentation of the movie for the viewer.

In another embodiment, the viewer is able to automatically or manually control pausing and restarting of the presentation of the movie while the query is identified and processed. For example, the viewer can select an option for automatic control, such that while a query is being processed presentation of the movie is automatically paused, and automatically restarted after presentation of the response. Also, the viewer is able to manually control pause and restart. In this case, the viewer may be given control over execution of the instance when a query is identified and is being processed, such as via a selectable button on a user interface or through a voice command. As such, the viewer may manually pause presentation of the movie while the query is being processed, and manually restart the presentation of the movie after the response is presented.

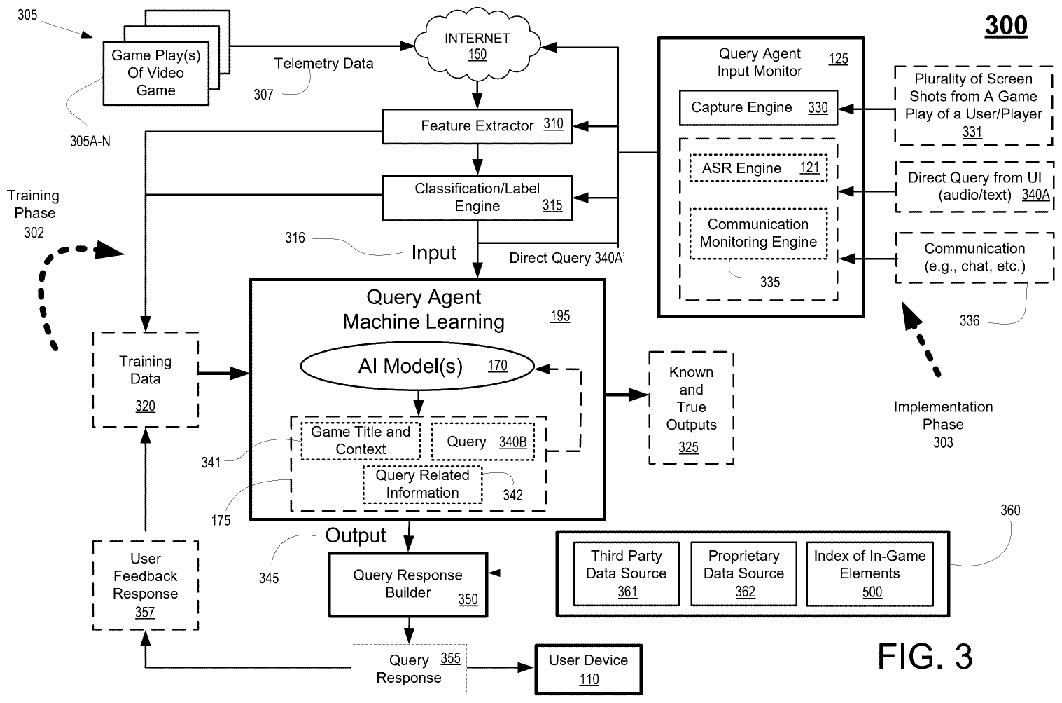

FIG. 3 is an illustration of a system 300 configured to implement one or more AI models 170 configured for classifying contexts corresponding to one or more points during a game play of a video game, and to identify queries related to the game play and generate responses to the queries using artificial intelligence that is context aware of during the game play of the video game, in accordance with one embodiment of the present disclosure. The system may be implemented during game play of a video game to help the user become familiar with the video, such as aiding the user to use proper terminology for the video game during communication. In addition, the system may be implemented during one or more game plays of the video game to train the AI model 170, which may include one or more sub-level or compartmentalized AI models. As such, FIG. 3 is an illustration of a training phase and an implementation phase of AI model 170 that is configured, in part, to identify and/or classify a query related to game play of a video game of a user, identify information related to the query, and/or generate a response to the query during the game play. Advantageously, the response to the query can be generated in real-time using reduced amounts of data for processing.

For purposes of illustration, the system of FIG. 3 may be implemented by the cloud game network 190, or the client device 110A, or secondary device 101 of FIG. 1, or a combination thereof. Further, the system may be implemented through a third party or mid-level query agent communicatively coupled through a network. Although system 300 is configured for identifying queries, and information related to those queries, and generating responses to those queries in relation to a game play of a video game, system 300 can also be implemented for providing the same services to other media content, such as a movie in other embodiments of the present disclosure.

In particular, queries, information related to the queries, and responses to those queries may be identified and/or classified and/or generated using the AI model 170, also referred to as an AI learning model. The AI model is updateable by providing feedback and/or trusted data to continually train the AI model. In one embodiment, the AI learning model is a machine learning model configured to apply machine learning to classify levels of immersion in a game play of a specific player. In another embodiment, the AI learning model is a deep learning model configured to apply deep learning to classify levels of immersion of the player during game play, wherein machine learning is a sub-class of artificial intelligence, and deep learning is a sub-class of machine learning. As such, artificial intelligence is used to identify, classify, and/or generate queries, information related to the queries, and responses to those queries during game play of a video game by a user.

As shown, the AI model 170 may be configured for a training phase (e.g., horizontal direction through the AI model 170 to learn one or more relevant items of data, including in-game elements of a video game, context at a plurality of points during one or more game plays of the video game, queries related to the game plays, and/or responses to those queries. For example, game plays of a video game can be monitored and provided as input to the AI model 170 to for learning. Also, the AI model 170 may be configured for an implementation phase (e.g., vertical direction through the AI model) for purposes of identifying a context of a current point in the game play, identifying an active or passive query of a user based on the context, identify information related to the query (e.g., relevant in-game elements) based on the context, and/or generate a response to the query based on the context that may optionally include the information, all performed during a current game play of the video game by the user. Because the implementation phase relies on an analysis of screen shots of the game play (i.e., instead of using game state data that may be cumbersome) to determine a context of the game play, the processes performed by the AI model can be performed in real-time, such as providing relevant information to the user.

During the training phase 302, telemetry data 307 is collected from a plurality of game plays 305, including game plays 350A-N and/or screen shots or video frames of the game plays, of one or more players playing a video game. The telemetry data may be collected through a communication network 150, or directly delivered. Telemetry data may include game state data, video frames, screen shots, user saved data, and metadata. Specifically, game state data defines the state of the game play of an executing video game for a player at a particular point in time. Game state data allows for the generation of the gaming environment at the corresponding point in the game play. For example, game state data may include states of devices used for rending the game play (e.g., states of the CPU, GPU, memory, register values, etc.), identification of the executable code to execute the video game at that point, game characters, game objects, object and/or game attributes, graphic overlays, and other information. User saved data includes information that personalizes the video game for the corresponding player. For example, user saved data may include character information and/or attributes that are personalized to a player (e.g., location, shape, look, clothing, weaponry, assets, etc.) in order to generate a character and character state that is unique to the player for the point in the game play, game attributes for the player (e.g., game difficulty selected, game level, character attributes, character location, number of lives, trophies, achievements, rewards, etc.), user profile data, and other information. Metadata is configured to provide relational information and/or context for other information, such as the game state data and the user saved data. For example, metadata may include information describing the gaming context of a particular point in the game play of a player, such as where in the game the player is, type of game, mood of the game, rating of game (e.g., maturity level), the number of other players there are in the gaming environment, game dimension displayed, the time of the collection of information, the types of information collected, region or location of the internet connection, which players are playing a particular gaming session, descriptive information, game title, game title version, franchise, format of game title distribution, network connectivity, downloadable content accessed, links, language, system requirements, hardware, credits, achievements, awards, trophies, and other information.

The telemetry is delivered to the feature extractor 310 that is configured to extract out the salient and/or relevant features from the telemetry data 307 that is useful in identifying and/or classifying in-game elements of a video game, context at a plurality of points during one or more game plays of the video game, queries related to the game plays, information related to the queries, and/or responses to those queries that optionally may utilize the information.

The feature extractor may be configured to define features that are associated with game contexts, in-game elements, relevant information of the video game, game title, controller inputs, and other relevant data. In some implementations, both feature definition and extraction is performed by the AI model 170, such that feature learning and extraction is performed internally within the AI model. In addition, extracted features are classified or labeled by classification/label engine 315. In that manner, the extracted features can be classified and/or labeled (e.g., as gaming context data, user input data, in-game element data, query based data, query related data including relevant information, response generation data, etc.). In another embodiment, the extraction and/or classification of features may be performed by the deep/machine learning engine 195. Data obtained from the feature extractor 310 and/or the classification/label engine 315 may be collected as training data 320 for submission to the query agent machine learning engine 195 for training the AI model 170.

As shown, the deep/machine learning engine 195 is configured for implementation of AI model 170 for training and/or implementation based on an input set of data (e.g., extracted features that may be further classified and/or labeled. In one embodiment, the AI model 170 is a machine learning model configured to apply machine learning to identify/learn/classify in-game elements of a video game, contexts of points during game play of the video game, passive or active queries related to the game plays, information related to the queries, and/or responses to those queries. In another embodiment, the AI learning model is a deep learning model configured to apply deep learning to perform the same operations, wherein machine learning is a sub-class of artificial intelligence, and deep learning is a sub-class of machine learning.

Purely for illustration, the deep/machine learning engine 195 may be configured as a neural network used to train and/or implement the AI model 170, in accordance with one embodiment of the disclosure. Generally, the neural network represents a network of interconnected nodes responding to input (e.g., extracted features) and generating an output related generally to the video game (e.g., context, in-game elements, recognizing queries, generating response, etc.). That is the AI model 170 is trained to learn one or more aspects of a video game, such that at a current point in a game play of a video game the AI model is able to identify and/or classify a context of a game play of a video game, identify a passive and/or active query of the game play, information related to the query, and generate a response to the query optionally using the information during the game play of the video game. Generally, the neural network in the machine learning engine 190 represents a network of interconnected nodes, such as an artificial neural network, and is used to train the AI model 170. In one implementation, the AI neural network includes a hierarchy of nodes. For example, there may be an input layer of nodes, an output layer of nodes, and intermediate or hidden layers of nodes. Input nodes are interconnected to hidden nodes in the hidden layers, and hidden nodes are interconnected to output nodes. Each node learns some information from data. Knowledge can be exchanged between the nodes through the interconnections. Interconnections between nodes may have numerical weights that may be used link multiple nodes together between an input and output, such as when defining rules of the AI model 170. Input to the neural network activates a set of nodes. In turn, this set of nodes activates other nodes, thereby propagating knowledge about the input. This activation process is repeated across other nodes until an output is provided

During the training phase 302, training data 320 (e.g., extracted features and/or classified features) may be provided as input to the machine learning system 195, which implements a training algorithm to fit the structure of the AI model 170 to the training data by tweaking the parameters of the AI model, so that the trained AI model provides an accurate relationship between input (training data) and output. As such, the training data 320 is fed to the machine learning engine 195, which utilizes artificial intelligence, including supervised learning algorithms, unsupervised learning algorithms, reinforcement learning, or other artificial intelligence-based algorithms to build the AI model 170. In particular, training and/or learning may be supervised using known and true outputs 325 (e.g., in-game elements, contexts, information of a video game, known queries, known responses, etc.) associated with the training data 320. Training and/or learning may be unsupervised, wherein no known or true outputs are provided for the training data 320, such that input data is only provided and the AI model 170 learns to determine gaming contexts, in-game elements, related information, possible queries, possible responses to the queries, etc. of a video game. Also, training may implement both supervised and unsupervised training. For example, after performing unsupervised training, supervised learning may be performed with known data.

In particular, the AI model 170 is configured to apply rules defining relationships between features and outputs (e.g., gaming contexts, in-game elements, related information, queries, responses to queries, etc.), wherein features may be defined within one or more nodes that are located at one or more hierarchical levels of the AI model 170. The rules link features (as defined by the nodes) between the layers of the hierarchy, such that a given input set of data leads to a particular output (e.g., level of immersion of the player during game play of a video game) of the AI model 170. For example, a rule may link (e.g., using relationship parameters including weights) one or more features or nodes throughout the AI model 170 (e.g., in the hierarchical levels) between an input and an output, such that one or more features make a rule that is learned through training of the AI model 170. That is, each feature may be linked with one or more features at other layers, wherein one or more relationship parameters (e.g., weights) define interconnections between features at other layers of the AI model 170. As such, each rule or set of rules corresponds to a classified output.

As such, the neural network in the machine learning engine 195 configured to build the AI model 170 may identify and/or classify one or more items of data of a video game. For example, the AI model is configured to identify and/or classify one or more of the following in relation to a video game: in-game elements; a plurality of contexts during game plays; information related to the video game, such as game title, descriptions of the in-game elements, etc.; passive and/or active queries based on corresponding contexts; and/or responses to the queries. In particular, the AI model 170 is trained, based on game state data and/or video frames of game plays, to identify plurality of contexts of a plurality of points in the plurality of game plays, wherein game state data may be used for learning and/or verification of the contexts. Further, the AI model is trained, based on the game state data and/or video frames of game plays, to identify in-game elements and build a database or index including the plurality of in-game elements and a plurality of descriptions corresponding to the plurality of in-game elements for use by the AI model 170 when generating responses to queries.

Based on these predictive results, the neural network 195 is configured to define an AI model 170 that is used to identify/classify and/or predict a context 341 of a current point during a game play of the video game, an active or passive query 340B of a user in relation to the game play based on the context, information related to the query (e.g., in-game elements, etc.), and further generate and/or match a response 355 to the identified query, wherein the response may include the identified information 342 that is related to the query (e.g., descriptions of in-game elements, game title, etc.). As such, the resulting output 345 according to the rules of the AI model 135 may predict an active and/or passive query related to a game play of a video game for a user, based on an identified gaming context of the game play, and further generate a response 355 to the query.

In particular, during the implementation phase 303 data is captured by the query agent input monitor 125 for input into the query agent machine learning engine 195. For example, a plurality of screen shots 331 and/or video frames from a game play of a video game of a user is collected by a capture engine 330. The screen shots may be provided to the feature extractor 310 to identify salient and relevant information related to context identification. Further, the extracted features may be classified and/or labeled by the classification/label engine 315 prior to submission to the AI model 170. In some implementations, feature extraction and/or classification are performed by the AI model. As such, the AI model is configured at least to identify and/or determine a context of a current point in the game play based on the one or more video frames that are captured. The context that is identified forms the basis of additional operations performed by the query agent, such as identifying a passive and/or active query based on the context. For example, the AI model provides contextual data 341 as a preliminary output 175, such as game title of the video game, and/or context of a current point in the game play of the video game.

In addition, a user may provide an active and direct query 340A that may be presented in audio or text form, with the intention of receiving a response to the query. The query 340A may be identified without using artificial intelligence. For example, the query 340A may be presented in text form via a user interface, or may be presented in audio form (e.g., as a command) that is captured by a receiver associated with the user interface. A communication monitoring engine 335 may be tasked to provide voice command monitoring. The direct query may be analyzed and/or processed by an automatic speech recognition (ASR) engine 330 to translate the query to a format suitable for use by downstream components (e.g., the AI model 170) and/or give meaning and understanding to the query. After translation, the direct query 340A may be provided as input 316 to the query agent machine learning engine 195 for processing by the AI model 170 (e.g., verify the query using artificial intelligence and/or generate a response to the query).

In addition, communication monitoring engine 335 may be configured to monitor communication 336 (e.g., a chat thread between two or more players or users, self-talking, muttering, voice commands provided by a user, etc.) for purposes of identifying active and/or passive queries 340B using artificial intelligence. The communication 336 may be analyzed and/or processed by an ASR engine 330 to translate the communication provided in one format to another format suitable for use by downstream components (e.g., the AI model 170). For example, the communication 336 may be analyzed using artificial intelligence to identify an active and/or passive query of the user. As such, the communication 336 that is optionally translated may be provided to the feature extractor 310 to identify salient and relevant information related to query identification. Further, the extracted features may be classified and/or labeled by the classification/label engine 315 prior to submission to the AI model 170. In some implementations, feature extraction and/or classification are performed by the AI model. As such, from at least the communication 336 the AI model is configured at least to identify and/or determine a query 340B based on the context of a current point in the game play. Because the AI model 170 is context aware of a current point in the game play, any bits of relevant information that is actively and/or passively obtained, including basic and/or incomplete information, can be used to identify a query. That is, the AI model can complete a direct query 340A that is presented by the user into a query 340B that is more meaningful using artificial intelligence. Also the AI model can identify a passive query that may be helpful to the user in one or more activities, such as making the user more knowledgeable about the video game when participating in a conversation between two or more players playing the video game (e.g., during a chat, or discussion, or phone call, or in-person discussion, etc.).

In addition, the AI model 170 is configured to determine information 342 related to the query 340A and/or 340B that are identified. For example, keywords may be identified in the query that is related to in-game elements and their descriptions, or other relevant information. The information may be accessed from or derived from one or more data sources 360, including a third party data source 361 (e.g., accessed over a communication network, such as the internet), a proprietary data source 362 (e.g., in-house game service provider having information related to one or more video games), or an index of in-game elements 500, that may be built using the AI model 170. The information 342 may be used by the AI model to generate a response 355 to the query as output 345, wherein the information may optionally be included in the response.

As such, during the implementation phase 303, the identified query 340A and/or 340B, the context 341, and information 342 related to the query may be re-input back into the AI model 170 to generate a response to the query. That is, the AI model 170 is used to generate and/or match a response to the query that is identified during a game play of a video game based on the context of a particular point in the game play. That is, for a given set of extracted features that are classified and provided as input to the AI model 170, a response to the query 340A and/or 340B is provided as output 345. The query response builder 350 may take the output 345 and formulate a query response 355 that is understandable and in a suitable format for presentation by a downstream device to a user, such as a user interface or speaker on player device 110 or secondary device 101 of the user. In particular, the query response builder 350 may include information accessed from or derived from one or more data sources 360, previously described. For example, the response may directly include information obtained from a data source, or may include a link to information accessed through one of the data sources 360.

In addition, the user may provide feedback response 357 during the game play as to the value of the output provided by the AI model 170 (e.g., query response 355). For example, the feedback may be in the form of a tag that indicates whether the user liked or disliked the output by the AI model. That is, feedback may be provided indicating that the response for a predicted active and/or passive query for a given gaming context of a game play is valuable or not valuable, or have some middle valuation. The information provided as feedback may be newly included within the training data 120, and provided as input into the machine learning engine 195 for purposes of updating the AI model 170. Because the information is verified (e.g., by the player), the machine learning engine could apply a supervised learning algorithm by assigning the verified output as being a true output 125 when updating the AI model, in one embodiment.

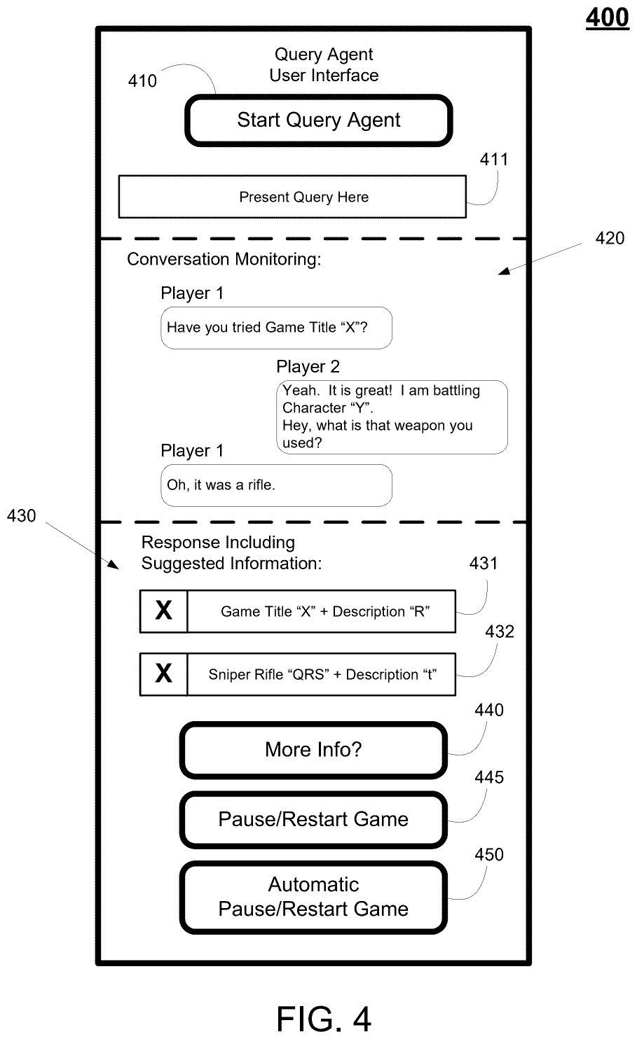

FIG. 4 illustrates a user interface 400 used for interacting with a query agent that is configured to identify a context of a game play of a video game, identify a query based on the context and related to the game play, identify relevant information of the query, and generate a response to the query using artificial intelligence that is context aware of a current point in the game play, in accordance with one embodiment of the present disclosure. For example, user interface 400 may be implemented by the client device 110 and/or the secondary device 101 of a corresponding user.

A shown, interaction button 410 when selected by the user provides for starting a query agent to access services that are provided in real-time during a game play of a video game, as previously described. For example, the query agent automatically captures data for purposes of identifying context in the game play, identifying a passive and/or active query based on the identified context, identifying relevant information of the query, and/or generating a response to the query based on the context, wherein the response may include the relevant information.

In addition, query input interface 411 is configured for direct entry of a query by the user. That is, the query is actively presented by the user with the intent of receiving a response to the query. For example, when the user has need for additional information related to a video game, the query input interface allows for the user to present a query directly to the query agent during the game play of the video game. As an illustration, the direct query may be presented by a user requesting information related to a weapon used for battling a character “Y”, without anything more. In one implementation, interaction with the query input interface 411 by a user may automatically start the query agent.

One of the services provided by the query agent is communication monitoring, such as for purposes of capturing active and/or passive queries. As shown, user interface 400 displays a communication 420 or conversation thread between two players, such as a participation in a chat channel by player 1 and player 2. In the conversation thread, player 2 is discussing with player 1 a battle with a character “Y”in a video game with game title “X”. Though player 2 is not actively presenting a query, the query agent supported by artificial intelligence is configured to identify a passive query presented by player 2. In the passive query, the query agent recognizes that player 2 wants information about a weapon used to battle character “Y”, but is not actively seeking that information from the query agent. In addition, the query agent may be able to determine that player 1 does not provide sufficient information to properly identify the weapon by player 2. The passive query may be determined using artificial intelligence because there is context identification of the game play, such as the game play of player 2, or the game play of both players in a multi-player gaming session.

Further, the query agent may be able to make the direct query presented in query input interface 411 based on the identified context of the game play. That is, a more complete query may meaningfully ask for the name of the weapon used to defeat character “Y” in-game title “X” of the video game, wherein the character is encountered in map location “P” on level 3.

A response is generated by the query agent using artificial intelligence for the active and/or passive query that is identified. The response may include one or more items of information, including a game title of the video game and a description “R” of the video game that are presented in block 431. The response may include information presented in block 432 related to the in-game element that is the subject of the query. In particular, the information may indicate that the in-game element referenced in the query is a sniper rifle with model reference “QRS”, and may include a description “t” of the in-game element. For purposes of illustration only, the Sniper Rifle QRS may be listed in the index 500 of FIG. 5 built for the video game.

Additional interfaces may be provided. For example, interaction button 440 may be selected by the user to request additional information related to the query, and more specifically more information related to the in-game element, sniper rifle “QRS”. Also, selection of interaction button 445 may allow the user to manually pause and/or restart execution of an instance of the video game for the game play while the query is being processed. Further, interaction button 450 may be selected by the user for purposes of automatically pausing execution of the instance of the video game for the game play while the query is being processed; and automatically restarting the execution of the instance of the video game for the game play after the response is presented.

FIG. 5 illustrates an index 500 of in-game elements of a video game that is built using artificial intelligence, in accordance with one embodiment of the present disclosure. As previously described, the index 500 may include in-game elements identified through training of an AI model based on the game state data and/or video frames of game plays of a video game. As such, a database and/or index 500 may be built including the plurality of in-game elements and a plurality of descriptions corresponding to the plurality of in-game elements for use by the AI model when generating responses to queries. The index is built for a video game with game title “X” as identified using artificial intelligence, as shown in block 505, wherein block 506 includes a description “R”of the identified video game.

Various columns are presented in the index 500, including column 501 which describes the name of the in-game element; column 502 which provides a context of the in-game element, such as when first encountered in the video game; and column 503 which provides a description of the in-game element. The index 500 may be broken into one or more element types. For purposes of illustration only, index 500 includes elements of two types, though additional types may be supported. For example, index 500 includes in-game elements represented by a character type 510, and in-game elements represented by an object type 530.

In-game elements of a character type 510 provided in index 500 includes characters 1 through N, with corresponding context and descriptions. For example, block 511 provides the name of a character (e.g., character 1), block 512 provides a context for character 1 (e.g., encountered in level 1 with a context 1, such as a corresponding scene), and block 513 provides a description of character 1 (e.g., description “a”). Also, block 521 the name of another character (e.g., character 2), block 522 provides a context for character 2 (e.g., encountered in level 1 with a context 2, such as a corresponding scene), and block 523 provides a description of character 2 (e.g., description “b”). Index 500 is configured to provide information related to additional character in-game elements.

In-game elements of object type 530 provided in index 500 includes objects 1 through N, with corresponding context and descriptions. For example, block 531 provides the name of an object (e.g., object 1), block 532 provides a context for object 1 (e.g., encountered in level 3 with a context “m”, such as a corresponding scene), and block 533 provides a description of object 1 (e.g., description “x”). Also, block 541 provides the name of an object (e.g., object 2), block 542 provides a context for object 2 (e.g., encountered in level 7 with a context “p”, such as a corresponding scene), and block 543 provides a description of object 2 (e.g., description “y”). In addition, block 551 provides the name of an object (e.g., Sniper Rifle QRS), block 552 provides a context for the object (e.g., encountered in level 8 with a context “r”, such as a corresponding scene), and block 553 provides a description of the object (e.g., description “t”). The in-game element names Sniper Rifle QRS is used in the example provided in the description of the user interface 400 of FIG. 4. Also, block 561 provides the name of an object (e.g., object “N”), block 562 provides a context for the object “N” (e.g., encountered in level 17 with a context “f”, such as a corresponding scene), and block 563 provides a description of the object “N” (e.g., description “z”). As such, index 500 is configured to provide information related to additional object in-game elements.

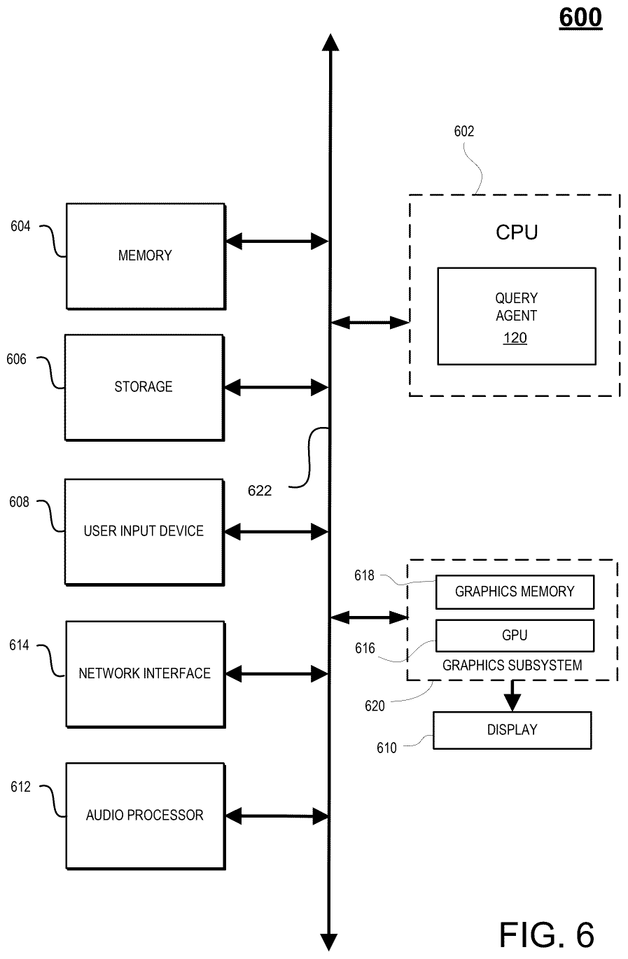

FIG. 6 illustrates components of an example device 600 that can be used to perform aspects of the various embodiments of the present disclosure. This block diagram illustrates a device 600 that can incorporate or can be a personal computer, video game console, personal digital assistant, a server or other digital device, and includes a central processing unit (CPU) 602 for running software applications and optionally an operating system. CPU 602 may be comprised of one or more homogeneous or heterogeneous processing cores. Further embodiments can be implemented using one or more CPUs with microprocessor architectures specifically adapted for highly parallel and computationally intensive applications.

In particular, CPU 602 may be configured to implement a query agent 120 that is configured to provide responses to active and/or passive queries that are identified during game play of a video game that is context aware using artificial intelligence. For example, artificial intelligence is used to help players recall the correct names of in-game elements, and further provides additional context and/or information related to the in-game elements, such as by providing corresponding descriptions and/or linking and/or providing links to additional information over a communication network (e.g., internet). In that manner, the player is able to be fully aware of information related to the video game during activities related to the game play of the video game (e.g., the game play, discussions about the game play, etc.).

Memory 604 stores applications and data for use by the CPU 602. Storage 606 provides non-volatile storage and other computer readable media for applications and data and may include fixed disk drives, removable disk drives, flash memory devices, and CD-ROM, DVD-ROM, Blu-ray, HD-DVD, or other optical storage devices, as well as signal transmission and storage media. User input devices 608 communicate user inputs from one or more users to device 600, examples of which may include keyboards, mice, joysticks, touch pads, touch screens, still or video recorders/cameras, tracking devices for recognizing gestures, and/or microphones. Network interface 614 allows device 600 to communicate with other computer systems via an electronic communications network, and may include wired or wireless communication over local area networks and wide area networks such as the internet. An audio processor 612 is adapted to generate analog or digital audio output from instructions and/or data provided by the CPU 602, memory 604, and/or storage 606. The components of device 600 are connected via one or more data buses 622.

A graphics subsystem 620 is further connected with data bus 622 and the components of the device 600. The graphics subsystem 620 includes a graphics processing unit (GPU) 616 and graphics memory 618. Graphics memory 618 includes a display memory (e.g., a frame buffer) used for storing pixel data for each pixel of an output image. Pixel data can be provided to graphics memory 618 directly from the CPU 602. Alternatively, CPU 602 provides the GPU 616 with data and/or instructions defining the desired output images, from which the GPU 616 generates the pixel data of one or more output images. The data and/or instructions defining the desired output images can be stored in memory 604 and/or graphics memory 618. In an embodiment, the GPU 616 includes 3D rendering capabilities for generating pixel data for output images from instructions and data defining the geometry, lighting, shading, texturing, motion, and/or camera parameters for a scene. The GPU 616 can further include one or more programmable execution units capable of executing shader programs. In one embodiment, GPU 616 may be implemented within an AI engine (e.g., machine learning engine 195) to provide additional processing power, such as for the AI, machine learning functionality, or deep learning functionality, etc.

The graphics subsystem 620 periodically outputs pixel data for an image from graphics memory 618 to be displayed on display device 610. Display device 610 can be any device capable of displaying visual information in response to a signal from the device 600.

In other embodiments, the graphics subsystem 620 includes multiple GPU devices, which are combined to perform graphics processing for a single application that is executing on a CPU. For example, the multiple GPUs can perform alternate forms of frame rendering, including different GPUs rendering different frames and at different times, different GPUs performing different shader operations, having a master GPU perform main rendering and compositing of outputs from slave GPUs performing selected shader functions (e.g., smoke, river, etc.), different GPUs rendering different objects or parts of scene, etc. In the above embodiments and implementations, these operations could be performed in the same frame period (simultaneously in parallel), or in different frame periods (sequentially in parallel).

Accordingly, in various embodiments the present disclosure describes systems and methods configured for providing responses to active and/or passive queries during game play of a video game using artificial intelligence that is context aware of a current point during the game play.

It should be noted, that access services, such as providing access to games of the current embodiments, delivered over a wide geographical area often use cloud computing. Cloud computing is a style of computing in which dynamically scalable and often virtualized resources are provided as a service over the Internet. For example, cloud computing services often provide common applications (e.g., video games) online that are accessed from a web browser, while the software and data are stored on the servers in the cloud.

A game server may be used to perform operations for video game players playing video games over the internet, in some embodiments. In a multiplayer gaming session, a dedicated server application collects data from players and distributes it to other players. The video game may be executed by a distributed game engine including a plurality of processing entities (PEs) acting as nodes, such that each PE executes a functional segment of a given game engine that the video game runs on. For example, game engines implement game logic, perform game calculations, physics, geometry transformations, rendering, lighting, shading, audio, as well as additional in-game or game-related services. Additional services may include, for example, messaging, social utilities, audio communication, game play replay functions, help function, etc. The PEs may be virtualized by a hypervisor of a particular server, or the PEs may reside on different server units of a data center. Respective processing entities for performing the operations may be a server unit, a virtual machine, or a container, GPU, CPU, depending on the needs of each game engine segment. By distributing the game engine, the game engine is provided with elastic computing properties that are not bound by the capabilities of a physical server unit. Instead, the game engine, when needed, is provisioned with more or fewer compute nodes to meet the demands of the video game.

Users access the remote services with client devices (e.g., PC, mobile phone, etc.), which include at least a CPU, a display and I/O, and are capable of communicating with the game server. It should be appreciated that a given video game may be developed for a specific platform and an associated controller device. However, when such a game is made available via a game cloud system, the user may be accessing the video game with a different controller device, such as when a user accesses a game designed for a gaming console from a personal computer utilizing a keyboard and mouse. In such a scenario, an input parameter configuration defines a mapping from inputs which can be generated by the user's available controller device to inputs which are acceptable for the execution of the video game.

In another example, a user may access the cloud gaming system via a tablet computing device, a touchscreen smartphone, or other touchscreen driven device, where the client device and the controller device are integrated together, with inputs being provided by way of detected touchscreen inputs/gestures. For such a device, the input parameter configuration may define particular touchscreen inputs corresponding to game inputs for the video game (e.g., buttons, directional pad, gestures or swipes, touch motions, etc.).

In some embodiments, the client device serves as a connection point for a controller device. That is, the controller device communicates via a wireless or wired connection with the client device to transmit inputs from the controller device to the client device. The client device may in turn process these inputs and then transmit input data to the cloud game server via a network. For example, these inputs might include captured video or audio from the game environment that may be processed by the client device before sending to the cloud game server. Additionally, inputs from motion detection hardware of the controller might be processed by the client device in conjunction with captured video to detect the position and motion of the controller before sending to the cloud gaming server.

In other embodiments, the controller can itself be a networked device, with the ability to communicate inputs directly via the network to the cloud game server, without being required to communicate such inputs through the client device first, such that input latency can be reduced. For example, inputs whose detection does not depend on any additional hardware or processing apart from the controller itself can be sent directly from the controller to the cloud game server. Such inputs may include button inputs, joystick inputs, embedded motion detection inputs (e.g., accelerometer, magnetometer, gyroscope), etc.

Access to the cloud gaming network by the client device may be achieved through a network implementing one or more communication technologies. In some embodiments, the network may include 5th Generation (5G) wireless network technology including cellular networks serving small geographical cells. Analog signals representing sounds and images are digitized in the client device and transmitted as a stream of bits. 5G wireless devices in a cell communicate by radio waves with a local antenna array and low power automated transceiver. The local antennas are connected with a telephone network and the Internet by high bandwidth optical fiber or wireless backhaul connection. A mobile device crossing between cells is automatically transferred to the new cell. 5G networks are just one communication network, and embodiments of the disclosure may utilize earlier generation communication networks, as well as later generation wired or wireless technologies that come after 5G.

In one embodiment, the various technical examples can be implemented using a virtual environment via a head-mounted display (HMD), which may also be referred to as a virtual reality (VR) headset. As used herein, the term generally refers to user interaction with a virtual space/environment that involves viewing the virtual space through an HMD in a manner that is responsive in real-time to the movements of the HMD (as controlled by the user) to provide the sensation to the user of being in the virtual space or metaverse. An HMD can be worn in a manner similar to glasses, goggles, or a helmet, and is configured to display a video game or other metaverse content to the user. The HMD can provide a very immersive experience in a virtual environment with three-dimensional depth and perspective.

In one embodiment, the HMD may include a gaze tracking camera that is configured to capture images of the eyes of the user while the user interacts with the VR scenes. The gaze information captured by the gaze tracking camera(s) may include information related to the gaze direction of the user and the specific virtual objects and content items in the VR scene that the user is focused on or is interested in interacting with.

In some embodiments, the HMD may include an externally facing camera(s) that is configured to capture images of the real-world space of the user such as the body movements of the user and any real-world objects that may be located in the real-world space. In some embodiments, the images captured by the externally facing camera can be analyzed to determine the location/orientation of the real-world objects relative to the HMD. Using the known location/orientation of the HMD the real-world objects, and inertial sensor data from the, the gestures and movements of the user can be continuously monitored and tracked during the user's interaction with the VR scenes. For example, while interacting with the scenes in the game, the user may make various gestures (e.g., commands, communications, pointing and walking toward a particular content item in the scene, etc.). In one embodiment, the gestures can be tracked and processed by the system to generate a prediction of interaction with the particular content item in the game scene. In some embodiments, machine learning may be used to facilitate or assist in the prediction.

During HMD use, various kinds of single-handed, as well as two-handed controllers can be used. In some implementations, the controllers themselves can be tracked by tracking lights included in the controllers, or tracking of shapes, sensors, and inertial data associated with the controllers. Using these various types of controllers, or even simply hand gestures that are made and captured by one or more cameras, it is possible to interface, control, maneuver, interact with, and participate in the virtual reality environment or metaverse rendered on an HMD. In some cases, the HMD can be wirelessly connected to a cloud computing and gaming system over a network, such as internet, cellular, etc. In one embodiment, the cloud computing and gaming system maintains and executes the video game being played by the user. In some embodiments, the cloud computing and gaming system is configured to receive inputs from the HMD and/or interfacing objects over the network. The cloud computing and gaming system is configured to process the inputs to affect the game state of the executing video game. The output from the executing video game, such as video data, audio data, and haptic feedback data, is transmitted to the HMD and the interface objects.

Additionally, though implementations in the present disclosure may be described with reference to n HMD, it will be appreciated that in other implementations, non-HMDs may be substituted, such as, portable device screens (e.g., tablet, smartphone, laptop, etc.) or any other type of display that can be configured to render video and/or provide for display of an interactive scene or virtual environment. It should be understood that the various embodiments defined herein may be combined or assembled into specific implementations using the various features disclosed herein. Thus, the examples provided are just some possible examples, without limitation to the various implementations that are possible by combining the various elements to define many more implementations.

Embodiments of the present disclosure may be practiced with various computer system configurations including hand-held devices, microprocessor systems, microprocessor-based or programmable consumer electronics, minicomputers, mainframe computers and the like. Embodiments of the present disclosure can also be practiced in distributed computing environments where tasks are performed by remote processing devices that are linked through a wire-based or wireless network.

Although the method operations were described in a specific order, it should be understood that other housekeeping operations may be performed in between operations, or operations may be adjusted so that they occur at slightly different times or may be distributed in a system which allows the occurrence of the processing operations at various intervals associated with the processing, as long as the processing of the telemetry and game state data for generating modified game states and are performed in the desired way.

With the above embodiments in mind, it should be understood that embodiments of the present disclosure can employ various computer-implemented operations involving data stored in computer systems. These operations are those requiring physical manipulation of physical quantities. Any of the operations described herein in embodiments of the present disclosure are useful machine operations. Embodiments of the disclosure also relate to a device or an apparatus for performing these operations. The apparatus can be specially constructed for the required purpose, or the apparatus can be a general-purpose computer selectively activated or configured by a computer program stored in the computer. In particular, various general-purpose machines can be used with computer programs written in accordance with the teachings herein, or it may be more convenient to construct a more specialized apparatus to perform the required operations.

One or more embodiments can also be fabricated as computer readable code on a computer readable medium. The computer readable medium is any data storage device that can store data, which can be thereafter be read by a computer system. Examples of the computer readable medium include hard drives, network attached storage (NAS), read-only memory, random-access memory, CD-ROMs, CD-Rs, CD-RWs, magnetic tapes and other optical and non-optical data storage devices. The computer readable medium can include computer readable tangible medium distributed over a network-coupled computer system so that the computer readable code is stored and executed in a distributed fashion.

In one embodiment, the video game is executed either locally on a gaming machine, a personal computer, or on a server, or by one or more servers of a data center. When the video game is executed, some instances of the video game may be a simulation of the video game. For example, the video game may be executed by an environment or server that generates a simulation of the video game. The simulation, on some embodiments, is an instance of the video game. In other embodiments, the simulation maybe produced by an emulator that emulates a processing system.

Although the foregoing embodiments have been described in some detail for purposes of clarity of understanding, it will be apparent that certain changes and modifications can be practiced within the scope of the appended claims. Accordingly, the present embodiments are to be considered as illustrative and not restrictive, and the embodiments are not to be limited to the details given herein, but may be modified within the scope and equivalents of the appended claims.

What is claimed is:

1. A method, comprising:
capturing one or more video frames of a game play of the video game controlled by a user;
executing an artificial intelligence (AI) model to determine a context of a current point in the game play based on the one or more video frames that are captured;
determining a query based on the context of the game play using the AI model;
generating a response to the query using the AI model based on the context of the game play; and
presenting the response to the query via a device of the user.

2. The method of claim 1, further comprising:
capturing a plurality of video frames from a plurality of game plays of the video game; and
training the AI model to identify a plurality of contexts of a plurality of points in the plurality of game plays based on the plurality of video frames that are captured.

3. The method of claim 1, further comprising:
capturing a plurality of game state from a plurality of game plays of the video game;
training the AI model to identify a plurality of in-game elements of the video game; and
building a database including the plurality of in-game elements and a plurality of descriptions corresponding to the plurality of in-game elements for use by the AI model when generating the response.

4. The method of claim 3,
wherein the query is directed to a lore of or an object in the video game corresponding to an in-game element,
wherein the response includes information for the in-game element accessed from the database.

5. The method of claim 1, wherein the determining the query includes:
monitoring over a channel a conversation between two or more players playing the video game, wherein in the conversation the user is one of the two or more players;
translating the conversation to a format suitable for input into the AI model; and
identifying the query using the AI model based on the conversation and the context.

6. The method of claim 1, wherein the determining the query includes:
monitoring a voice communication of the user controlling the game play;
translating the voice communication of the user to a format suitable for input into the AI model; and
identifying the query using the AI model based on the voice communication that is translated and the context.

7. The method of claim 1, wherein the determining the query includes:
receiving the query in a user interface presented on the device of the user.

8. The method of claim 1, further comprising:
automatically pausing execution of an instance of the video game for the game play while the query is being processed; and
automatically restarting the execution of the instance of the video game for the game play after the response is presented.

9. The method of claim 1, wherein the presenting the response includes:
broadcasting the response using a speaker of the device of the user,
wherein the response is formatted in an audio format.

10. The method of claim 1, wherein the presenting the response includes:
presenting the response in a user interface presented on the device of the user,
wherein the response is formatted in a text format.

11. The method of claim 1, further comprising:
using the AI model to generate information related to a lore of or an object in the video game, wherein the query is directed towards the object;
determining the information is a spoiler of the lore of the video game for the current point in the game play; and
restricting presentation of the information in the response.

12. The method of claim 1, further comprising:
receiving a tag for the response to the query via a user interface presented on the device of the user;
providing the tag to the AI model as feedback for purposes of updating the AI model.

13. A method, comprising:
capturing one or more video frames during a presentation of a movie;
executing an artificial intelligence (AI) model to determine a context of a current point in the presentation of the movie based on the one or more video frames that are captured;
determining a query related to the presentation of the movie based on the context using the AI model;
generating a response to the query using the AI model based on the context of the presentation of the movie; and
presenting the response to the query via a device of a viewer of the movie.

14. The method of claim 13, further comprising:
capturing a plurality of video frames of the movie;
training the AI model to identify a plurality of contexts of a plurality of points in the movie based on the plurality of video frames that is captured; and
training the AI model to identify a plurality of in-movie elements of the movie;
generating a plurality of descriptions for the plurality of in-movie elements; and
building a database including the plurality of in-movie elements and the plurality of descriptions for use by the AI model when generating the response.

15. The method of claim 13, wherein the determining the query includes:
monitoring a voice communication of the viewer;
translating the voice communication of the viewer to a format suitable for input into the AI model; and
identifying the query using the AI model based on the voice communication that is translated and the context.

16. The method of claim 13, wherein the determining the query includes:
receiving the query in a user interface presented on the device of the viewer.

17. The method of claim 13, further comprising:
automatically pausing the presentation of the movie while the query is being processed; and
automatically restarting the presentation of the movie after the response is presented.

18. The method of claim 13, wherein the presenting the response includes:
broadcasting the response using a speaker of the device of the viewer, wherein the response is formatted in an audio format; or
presenting the response in a user interface presented on the device of the viewer, wherein the response is formatted in a text format.

19. The method of claim 13, further comprising:
using the AI model to generate information related to a plot of or an object in the movie, wherein the query is directed towards the plot or the object;
determining the information is a spoiler of the plot of the movie for the current point in the presentation of the movie; and
restricting presentation of the information in the response.

20. A computer system comprising:
a processor; and
memory coupled to the processor and having stored therein instructions that, if executed by the computer system, cause the computer system to execute a method comprising:
capturing one or more video frames of a game play of the video game controlled by a user;
executing an artificial intelligence (AI) model to determine a context of a current point in the game play based on the one or more video frames that are captured;
determining a query based on the context of the game play using the AI model;
generating a response to the query using the AI model based on the context of the game play; and
presenting the response to the query via a device of the user.
